(19) United States
(12) Patent Application Publication
(10) Pub. No.: US 2019/0063576 A1
(43) Pub. Date: Feb. 28, 2019

(54) DISCONNECTING AXLE ASSEMBLY INCLUDING AN ASYMMETRICALLY GEARED DIFFERENTIAL

(71) Applicant: American Axle & Manufacturing, Inc., Detroit, MI (US)

(72) Inventors: Paul J. Valente, Berkley, MI (US); James P. Downs, South Lyon, MI (US); Eric A. Rivett, Macomb, MI (US)

(21) Appl. No.: 15/686,199

(22) Filed: Aug. 25, 2017

(51) Int. Cl. F16H 48/11; B60K 17/02; B60K 23/04; F16H 57/037; F16D 13/52

(52) U.S. Cl. CPC F16H 48/11; B60K 17/02; F16D 13/52; F16H 57/037; B60K 23/04

(57) ABSTRACT

A disconnecting axle assembly for a vehicle can include a planetary differential and a clutch. The differential input can be meshingly engaged with an input pinion. The clutch can include first and second friction plates. The first plates can be non-rotatably but axially slidably coupled to a first differential output. The second plates can be interleaved with the first plates and non-rotatably but axially slidably coupled to a first axle half-shaft which can drive a first wheel. A second differential output can be drivingly coupled to a second axle half-shaft which can drive a second wheel. The differential can output a greater amount of torque to the first differential output than the second differential output when the vehicle is traveling in a straight line.

### FIELD

The present disclosure relates to a disconnecting axle assembly including an asymmetrically geared differential.

### BACKGROUND

This section provides background information related to the present disclosure which is not necessarily prior art.

Disconnecting axle assemblies, such as rear drive axles in all-wheel drive vehicles, typically include a differential to provide differential power to left and right wheels, and one or more disconnecting clutches to inhibit power output to the wheels. It is generally desirable that the differential provides equal torque to the left and right wheels when the vehicle is driving in a straight path with ideal surface conditions (i.e., full traction at both the left and right wheels). Thus, vehicle differentials are typically designed to have a 50/50 split of power between the left and right outputs of the differential during such vehicle operating conditions. However, it has been found that losses can occur through the disconnecting clutch which can result in the actual power output to the wheels being greater on the non-clutched side than the clutched side. While current disconnecting axle assemblies are well suited for certain applications, there exists a need for improved disconnecting axle assemblies.

### SUMMARY

This section provides a general summary of the disclosure, and is not a comprehensive disclosure of its full scope or all of its features.

In one form, the present disclosure provides for a disconnecting axle assembly for selectively driving a set of drive wheels of a vehicle that can include an input pinion, a first output member, a second output member, a differential, and a clutch. The input pinion can be supported for rotation about a first axis. The first output member can be supported for rotation about a second axis that is transverse to the first axis. The first output member can output torque to a first wheel of the set of drive wheels. The second output member can be supported for rotation about the second axis and can output torque to a second wheel of the set of drive wheels. The differential can include a differential input member, a first differential output, a second differential output, and a differential gearset. The differential input member can be supported for rotation about the second axis and can be meshingly engaged with the input pinion. The planetary gearset can be configured to receive input torque from the differential input member and to output differential torque to the first and second differential outputs. The second differential output can be drivingly coupled to the second output member. The differential can output a greater amount of torque to the first differential output than the second differential output when the vehicle is traveling in a straight line. The clutch can include a plurality of first friction plates and a plurality of second friction plates. The first friction plates can be non-rotatably but axially slidably coupled to the first differential output. The second friction plates can be interleaved with the first friction plates and non-rotatably but axially slidably coupled to the first output member.

According to a further embodiment, the second output member can be non-rotatably coupled to the second differential output.

According to a further embodiment, the differential gearset can be a hunting.

According to a further embodiment, the differential gearset can be at least partially non-factorizing.

According to a further embodiment, the planetary gearset can include an internal gear, a planet carrier, a plurality of planet gears, and a sun gear. The internal gear can be non-rotatably coupled to the differential input member. The first differential output can be coupled to the planet carrier for common rotation about the second axis. The second differential output can be coupled to the sun gear for common rotation about the second axis.

According to a further embodiment, the internal gear can have a total number of teeth and the sun gear can have a total number of teeth. The total number of teeth of the internal gear can be such that it is not a whole number multiple of the total number of teeth of the sun gear.

According to a further embodiment, the internal gear can have a total number of teeth and the sun gear can have a total number of teeth. The total number of teeth of the internal gear can be greater than twice the total number of teeth of the sun gear.

According to a further embodiment, the plurality of planet gears can include a set of first planet gears and a set of second planet gears. The first planet gears can be meshingly engaged with the sun gear. Each of the second planet gears can be meshingly engaged with the internal gear and a corresponding one of the first planet gears.

According to a further embodiment, a total number of teeth of each first planet gear, a total number of teeth of each second planet gear, a total number of teeth of the internal gear, and a total number of teeth of the sun gear can be different prime numbers.

According to a further embodiment, the total number of teeth of the internal gear can be 83. The total number of teeth of the sun gear can be 41. The total number of teeth of each first planet gear can be 17. The total number of teeth of each second planet gear can be 17. The set of first planet gears can consist of 3 of the first planet gears and the set of the second planet gears can consist of 3 of the second planet gears.

According to a further embodiment, the planetary gearset can include an internal gear, a planet carrier, a plurality of planet gears, and a sun gear. The internal gear can be non-rotatably coupled to the differential input member. The first differential output can be coupled to the sun gear for common rotation about the second axis and the second differential output can be coupled to the planet carrier for common rotation about the second axis.

According to a further embodiment, the internal gear can have a total number of teeth and the sun gear can have a total number of teeth. The total number of teeth of the internal gear can be less than twice the total number of teeth of the sun gear.

According to a further embodiment, the plurality of planet gears can include a set of first planet gears and a set of second planet gears. The first planet gears can be meshingly engaged with the sun gear. Each of the second planet gears can be meshingly engaged with the internal gear and a corresponding one of the first planet gears.

According to a further embodiment, a total number of teeth of each first planet gear, a total number of teeth of each second planet gear, a total number of teeth of the internal gear, and a total number of teeth of the sun gear can be different prime numbers.

According to a further embodiment, the set of first planet gears can consist of 3 of the first planet gears and the set of the second planet gears can consist of 3 of the second planet gears.

According to a further embodiment, the disconnecting axle assembly can further include a housing assembly. The housing assembly can include a main housing, a first end cap, and a second end cap. The first end cap and a first side of the main housing can define a clutch cavity. The second end cap and a second side of the main housing can define a differential cavity spaced apart from the clutch cavity. The main housing can include a central bore disposed about the second axis. The central bore can connect the clutch cavity with the differential cavity. The differential can be disposed within the differential cavity and the clutch can be disposed within the clutch cavity.

According to a further embodiment, the input pinion can be disposed axially between the clutch and the differential relative to the second axis.

In another form, the present disclosure provides for a disconnecting axle assembly for selectively driving a set of drive wheels of a vehicle. The disconnecting axle assembly can include a housing assembly, an input pinion, a first axle half-shaft, a second axle half-shaft, a differential, and a clutch. The input pinion can be supported for rotation relative to the housing assembly about a first axis. The first axle half-shaft can extend through a first side of the housing assembly and be supported for rotation relative to the housing assembly about a second axis that can be transverse to the first axis. The second axle half-shaft can extend through a second side of the housing assembly and be supported for rotation relative to the housing assembly about the second axis. The differential can be disposed within the housing assembly and can include a differential input gear, a first differential output, a second differential output, an internal gear, a planet carrier, a plurality of first planet gears, a plurality of second planet gears, and a sun gear. The differential input gear can be meshingly engaged with the input pinion. The internal gear can be non-rotatably coupled to the differential input gear. The planet carrier can support the first and second planet gears for rotation relative to the housing assembly about the second axis. The first planet gears can be meshingly engaged with the sun gear. Each second planet gear can be meshingly engaged with the internal gear and a corresponding one of the first planet gears. One of the sun gear or the planet carrier can be non-rotatably coupled to the second axle half-shaft. The clutch can include a plurality of first friction plates and a plurality of second friction plates. The first friction plates can be non-rotatably but axially slidably coupled to the other one of the sun gear or the planet carrier. The second friction plates can be interleaved with the first friction plates and non-rotatably but axially slidably coupled to the first axle half-shaft. The differential can output a greater amount of torque to the first friction plates than to the second axle half-shaft when an equal amount of rotational resistance is applied to the first and second axle half-shafts.

According to a further embodiment, the internal gear, the first planet gears, the second planet gears, and the sun gear form a hunting and non-factorizing gearset.

According to a further embodiment, a total number of teeth of each first planet gear can be equal to a total number of teeth of each second planet gear. A total number of teeth of the internal gear, a total number of teeth of the sun gear, and the total number of teeth of each of the first and second planet gears can be such that they have no common factors other than 1.

According to a further embodiment, a total number of teeth of each first planet gear, a total number of teeth of each second planet gear, a total number of teeth of the internal gear, and a total number of teeth of the sun gear can be different prime numbers.

Further areas of applicability will become apparent from the description and claims herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a motor vehicle equipped with an all-wheel drive driveline including a disconnecting axle assembly which includes a differential constructed in accordance with the present teachings;

FIG. 2 is a sectional view of the disconnecting axle assembly of FIG. 1;

FIG. 3 is an exploded view of a portion of the differential of FIG. 2; and

FIG. 4 is a sectional view of the differential of FIG. 2.

Corresponding reference numerals indicate corresponding parts throughout the several views of the drawings.

### DETAILED DESCRIPTION

Example embodiments will now be described more fully with reference to the accompanying drawings.

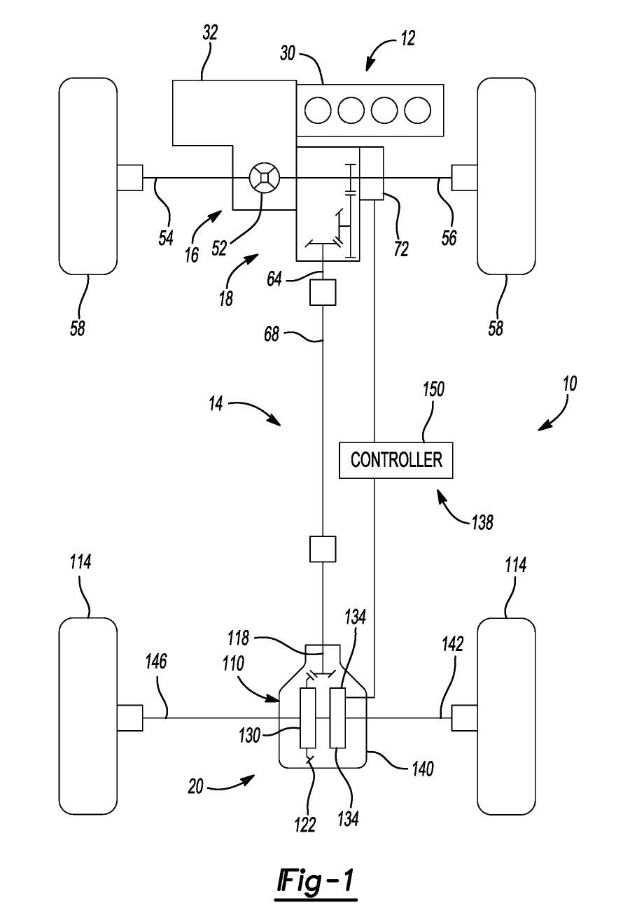

With reference to FIG. 1 of the drawings, an exemplary vehicle 10 is illustrated to include a powertrain 12 and a drivetrain 14 that can include a primary driveline 16, a power take-off unit (PTU) 18, and a secondary driveline 20. The powertrain 12 can include a prime mover 30, such as an internal combustion engine or an electric motor, and a transmission 32, which can be any type of transmission, such as a manual, automatic or continuously variable transmission. The prime mover 30 can provide rotary power to the transmission 32, which outputs rotary power to the primary driveline 16 and the PTU 18. The PTU 18 can be constructed in any suitable manner to be selectively operated to transmit rotary power to the secondary driveline 20. For example, the PTU 18 can be constructed as described in commonly-assigned U.S. Pat. No. 8,961,353, the disclosure of which is incorporated by reference as if fully set forth in detail herein.

In general, the primary driveline 16 can include a first differential 52 and a pair of axle half-shafts (first half-shaft 54 and second half-shaft 56) that can couple corresponding outputs of the first differential 52 to a first set of vehicle wheels 58. Generally, the first differential 52 can be driven by the transmission 32, and can include a means for transmitting rotary power to the first and second half-shafts 54, 56. In the example provided, the rotary power transmitting means is a differential gearset that can permit speed and torque differentiation between the first and second half-shafts 54, 56.

In general, the PTU 18 includes a PTU output member 64 that can be coupled to a propshaft 68 for common rotation about an axis (e.g., parallel to the longitudinal axis of the vehicle 10). The PTU 18 can also include a disconnect mechanism 72 to selectively control power transmission through the PTU 18 to thereby selectively drive the propshaft 68.

In the particular example provided, the secondary driveline 20 includes the propshaft 68 and a rear axle assembly 110 that is configured to receive rotary power from the propshaft 68 and to transmit rotary power to a second set of vehicle wheels 114. The rear axle assembly 110 can generally include an input pinion 118, an input gear 122, a second differential 130, a disconnect clutch 134, a control system 138, a housing assembly 140, a third half-shaft 142, and a fourth half-shaft 146.

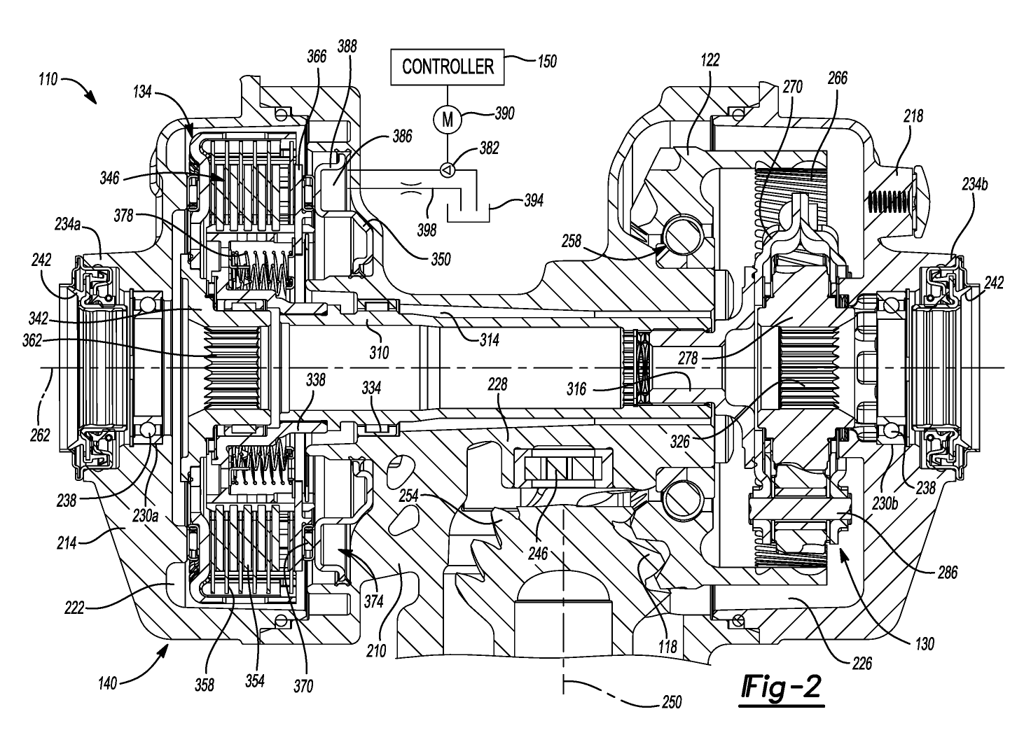

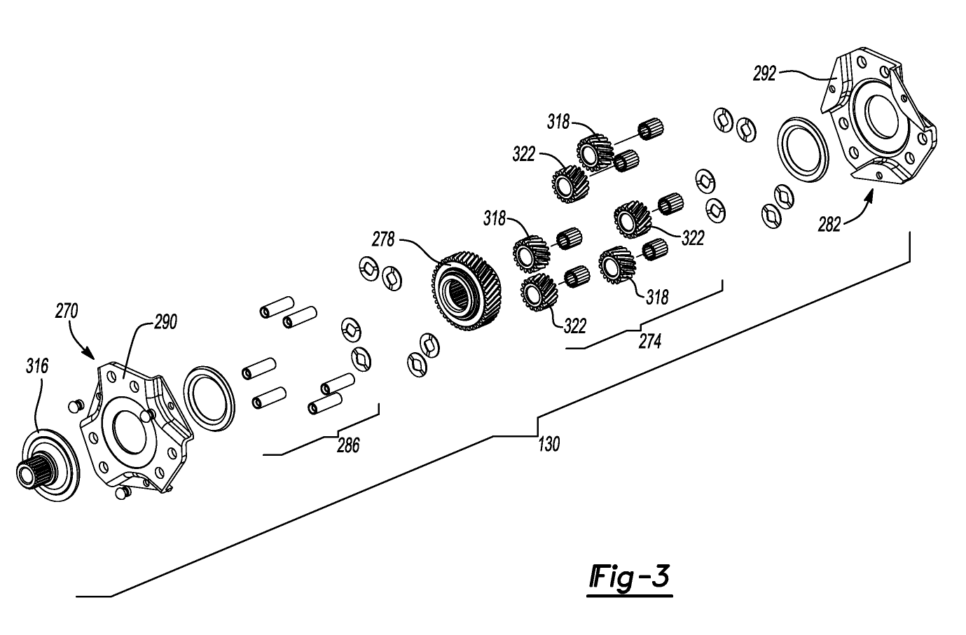

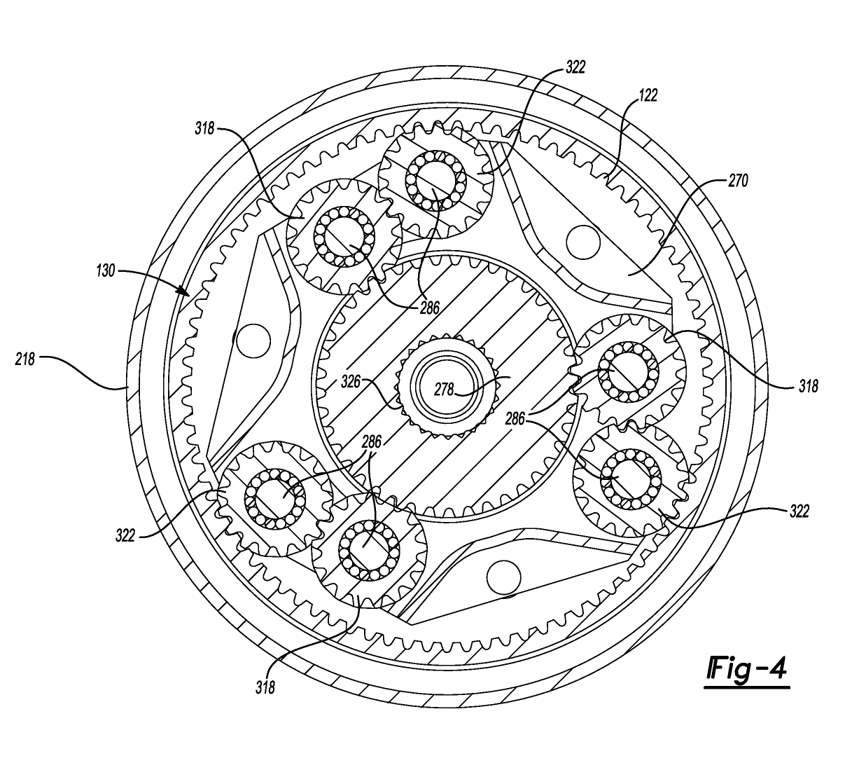

With reference to FIGS. 2-4 of the drawings, an example of the rear axle assembly 110 is illustrated in greater detail. Generally, and except as described herein, the rear axle assembly 110 can be configured as described in co-pending PCT International Application No. PCT/US2017/024031, the disclosure of which is hereby incorporated by reference as if fully set forth in detail herein.

Briefly, the axle housing assembly 140 can include a carrier or main housing 210, a first end cap 214, and a second end cap 218 that can be fixedly but removably coupled to the opposite axial ends of the carrier housing 210. The first end cap 214 can cooperate with a first axial end of the carrier housing 210 to define a clutch cavity 222 into which portions of the clutch 134 can be received, while the second end cap 218 can cooperate with a second, opposite axial end of the carrier housing 210 to define a differential cavity 226 into which the second differential 130 can be received. The clutch cavity 222 and the differential cavity 226 can be connected by a generally tubular portion 228 of the carrier housing 210.

The first and second end caps 214 and 218 can further define bearing mounts 230a and 230b, respectively, and seal mounts 234a and 234b, respectively. Bearings 238 can be mounted on the bearing mounts 230a and 230b and can be configured to support first and second output members (e.g., the third and fourth half-shafts 142, 146 shown in FIG. 1), respectively, for rotation relative to the axle housing assembly 140. Shaft seals 242 can be mounted on the seal mounts 234a and 234b and can be configured to form seals between the axle housing assembly 140 and the first and second output members (e.g., the third and fourth half-shafts 142, 146 shown in FIG. 1), respectively. The first and second end caps 214 and 218 can be sealingly engaged to the carrier housing 210 in any manner that is desired.

The input pinion 118 can be mounted on a tail bearing (not specifically shown) and a head bearing 246 that can support the input pinion 118 for rotation relative to the carrier housing 210 about a first axis 250. The head bearing 246 can be spaced apart from the tail bearing (not specifically shown) so that a pinion gear 254 of the input pinion 118 is disposed axially between the tail bearing (not shown) and the head bearing 246. The input gear 122 can be mounted on a bearing 258 (e.g., a four-point angular contact bearing) that can support the input gear 122 for rotation relative to the carrier housing 210 about a second axis 262. The second axis 262 can be transverse to the first axis 250. In the example provided, input gear 122 is a ring gear and the pinion gear 254 and the input gear 122 are a hypoid gearset such that the second axis 262 is perpendicular and offset from the first axis 250, though other configurations can be used.

The second differential 130 can be a planetary-type differential assembly and can be configured to receive input rotary power from the input gear 122 and output speed and torque differentiation to permit speed and torque differentiation between the third half-shaft 142 (FIG. 1) and the fourth half-shaft 146 (FIG. 1). The third and fourth half-shafts 142, 146 (FIG. 1) can be drivingly coupled to a respective one of the vehicle wheels 114 (FIG. 1). The second differential 130 can have an internal gear 266, a planet carrier 270, a plurality of planet gears 274, and a sun gear 278. The internal gear 266 can be fixedly coupled to the input gear 122 for common rotation about the second axis 262. In the particular example provided, the internal gear 266 is unitarily and integrally formed with the input gear 122. It will be appreciated, however, that the input gear 122 and the internal gear 266 could be formed as discrete components and coupled together via a connection means, such as a toothed or spline connection, welding and/or a plurality of fasteners.

The planet carrier 270 can comprise a carrier body 282 and a plurality of planet pins 286. The carrier body 282 can comprise a pair of carrier plates 290, 292 that can have a generally annular shape and can be spaced apart along the second axis 262 and fixedly coupled together. One of the carrier plates 290 can be coupled to a tubular shaft 310 for common rotation about the second axis 262. The tubular shaft 310 can be received through a central bore 314 of the tubular portion 228 of the carrier housing 210. In the example provided, the tubular shaft 310 can define a plurality of internal splines that can mate with external splines formed on a flange 316. The flange 316 can extend radially outward of the tubular shaft 310 and can be fixedly coupled to one of the carrier plates 290, such as by welding for example.

Each of the pins 286 can be coupled to the carrier plates 290, 292 and can journally support an associated one of the planet gears 274. In the example provided, the pins 286 are fixedly coupled to the carrier plates 290, 292. The plurality of planet gears 274 can include a plurality of pairs of the planet gears 274, each pair of the planet gears 274 including a first planet gear 318, and a second planet gear 322. In the example provided, there are three pairs of the planet gears 274, though other configurations can be used. Each second planet gear 322 can be meshingly engaged to the teeth of the internal gear 266, and each first planet gear 318 can be meshingly engaged to the associated one of the second planet gears 322 and to the sun gear 278. In the example provided, the sun gear 278 can have an internally splined aperture 326 that is configured to receive a matingly splined segment (not specifically shown) on the second output member (e.g., the fourth half-shaft 146 shown in FIG. 1).

The tubular shaft 310 can be supported for rotation relative to the generally carrier housing 210 via a bearing 334, such as roller or needle bearing. It will be appreciated that the sun gear 278 and the planet carrier 270 can be considered to be differential outputs of the second differential 130. The internal gear 266, planet gears 274, and sun gear 278 can have an asymmetrical gear ratio, such that when the internal gear 266 receives input torque from the input gear 122, and the planet gears 274 and the sun gear 278 can cooperate to provide an output torque to the planet carrier 270 that is greater than the output torque to the sun gear 278 under ideal conditions (e.g., when equal rotational resistance is applied to both the sun gear 278 and the planet carrier 270, such as when the vehicle 10 is driving in a straight path with full traction at both the left and right wheels).

For example, the number of teeth of the internal gear 266 can be a number that is not a whole number multiple of the number of teeth of the sun gear 278 and not a whole number multiple of the number of planet gear pairs, and the number of teeth of the sun gear 278 can be a number that is not a whole number multiple of the number of planet gear pairs. In the example provided, the number of teeth of the internal gear 266 can be greater than twice the number of teeth of the sun gear 278. The number of teeth of each first planet gear 318 can be equal to the number of teeth of each second planet gear 322. The number of teeth of the internal gear 266, the number of teeth of the sun gear 278, and the number of teeth of each of the first and second planet gears 318, 322 can be such that they have no common factors other than 1. In the example provided, the number of teeth of the internal gear 266, the number of teeth of the sun gear 278, and the number of teeth of each of the first and second planet gears 318, 322 are different prime numbers.

Thus, the second differential 130 can be fully hunting and non-factorizing, while providing asymmetric gearing with more torque directed toward the clutch 134 when the vehicle travels in a straight line and the left and right wheels have full traction. In the example provided, the internal gear 266 and the sun gear 278 both have odd numbers of teeth. In the example provided, the internal gear 266 can have a total of 83 teeth, each planet gear can have a total of 17 teeth, and the sun gear 278 can have a total of 41 teeth, though other numbers of teeth that provide asymmetric gearing with more torque directed toward the clutch 134 can be used. Thus, in the example provided, the output torque provided by the sun gear 278 to the second output (e.g., fourth half shaft 146 shown in FIG. 1) is approximately 49.4%, while the output torque provided by the planet carrier 270 to the clutch 134 is approximately 50.6% when equal rotational resistance is applied to both the first and second output members (e.g., half-shafts 142, 146 shown in FIG. 1), such as the vehicle travels in a straight line and the left and right wheels have full traction.

In an alternative construction, not specifically shown, the second differential 130 can include four pairs of the planet gears 274, such that there are four, equally circumferentially spaced first planet gears 318 and four equally spaced second planet gears 322. In such a construction diametrically opposed pairs of planet gears 274 can be in phase with each other out of phase with the pairs of planet gears 274 that are adjacent in the circumferential direction. For example, the adjacent planet gears 274 can be a half tooth out of phase with the pairs of planet gears 274 that are circumferentially 90 degrees apart. This condition can be known as being “counter phased” such that the planet gears 274 of the second differential 130 would be only 50% non-factorizing. In such an example, the number of teeth on the sun gear 278 and the internal gear 266 can be even while the number of teeth on the planet gears 274 can still be prime numbers.

Returning to the example provided, the clutch 134 can be any type of clutch that is configured to selectively transmit rotary power between the second differential 130 and the first output member (e.g., the third half-shaft 142 shown in FIG. 1). In the particular example provided, the clutch 134 is a friction clutch that comprises a first clutch portion 338, a second clutch portion 342, a clutch pack 346, and an actuator 350.

The first clutch portion 338 can be coupled to an end of the tube 310 that is opposite the planet carrier 270. The first clutch portion 338 can include an inner clutch hub onto which a plurality of first clutch plates 354 (of the clutch pack 346) can be non-rotatably but axially slidably engaged. The second clutch portion 342 can be an outer clutch housing or drum on which second clutch plates 358 (of the clutch pack 346) can be non-rotatably but axially slidably engaged. The first clutch plates 354 can be interleaved with the second clutch plates 358. The second clutch portion 342 can include an internally splined segment 362 that can be matingly engaged to an externally splined segment (not specifically shown) on the first output member (e.g., the third half-shaft 142 shown in FIG. 1).

The actuator 350 can include an apply plate 366, a thrust bearing 370, a cylinder assembly 374, one or more springs 378 (shown in FIG. 15), and a fluid pump 382. The apply plate 366 can be an annular structure that can be non-rotatably but axially slidably coupled to the second clutch portion 342. The cylinder assembly 374 can comprise a cylinder 386 and a piston 388. The cylinder 386 can be defined by an annular cavity formed in the carrier housing 210. The piston 388 can comprise an annular structure and a pair of seals that are mounted to the outside diametrical surface and the inside diametrical surface of the annular structure to form respective seals between the annular structure and outer and inner cylinder walls.

The thrust bearing 370 can be located or received on the apply plate 366, axially between the apply plate 366 and the piston 388. The springs 378 can bias the piston 388 in a predetermined return direction, such as toward a retracted position for example. In the example provided, the springs 378 can be disposed axially between the first clutch portion 338 and the apply plate 366, such that one end of each spring 378 can abut the first clutch portion 338 radially inward of the clutch pack 346, while the other end of the spring 378 can abut the apply plate 366. In this way, the springs 378 can bias the piston 388 toward the retracted position via the apply plate 366 and the thrust bearing 370, while maintaining load on the thrus bearing 370. The fluid pump 382 can be any type of pump, such as a gerotor pump for example, and can be mounted to the carrier housing 210, as will be described in more detail below.

In the example provided, the pump 382 is driven by an electric motor 390 that can be controlled by a controller 150 of the control system 138. In operation, the pump 382 can draw hydraulic fluid from a reservoir 394. While schematically shown, the reservoir 394 can be any suitable hydraulic fluid reservoir, such as a reservoir mounted to the carrier housing 140 or separate therefrom, and/or a sump of the clutch 134 and/or a sump of the second differential 130, for example. The pump 382 can pump the fluid to the cylinder 386. A bleed port 398 can fluidly couple the cylinder 386 to the reservoir 394 and be configured to restrict flow from the cylinder 386 to a flowrate that is less than the flowrate of the pump 382. In this way, the pump 382 can supply pressurized fluid to the cylinder 386 of the actuator 350 to move the piston 388 to compress the clutch pack 346 of the clutch 134. The pump 382 can be a reversible pump such that the pump 382 can be operated in a reverse mode to pump the fluid from the cylinder 386 to the reservoir 394.

Since the friction clutch 134 transfers torque via friction between the first and second friction plates 354, 358, the friction clutch 134 can selectively disconnect the first output member (e.g., the third half-shaft 142 shown in FIG. 1) from the second differential 130 to selectively control torque output from the rear axle assembly. Furthermore, since some rotary power can be lost through the clutch 134, the asymmetrical gearing of the second differential 130 can result in a more equal actual output torque provided to the wheels 114. Furthermore, the asymmetrical gear ratio of the second differential 130 provides the additional benefits of being hunting and non-factorizing.

In an alternative construction, not specifically shown, the sun gear 278 can be non-rotatably coupled to the tubular shaft 310 for transmission of torque to the clutch 134, while the planet carrier 270 can be non-rotatably coupled to the second output member (e.g., the fourth half-shaft 146 shown in FIG. 1). In such a configuration, the number of teeth of the internal gear 266 can be a number that is not a whole number multiple of the number of teeth of the sun gear 278 and not a whole number multiple of the number of planet gear pairs, and the number of teeth of the sun gear 278 is not a whole number multiple of the number of planet gear pairs. In such an example, the number of teeth of the internal gear 266 can be less than twice the number of teeth of the sun gear 278. The number of teeth of each first planet gear 318 can be equal to the number of teeth of each second planet gear 322. The number of teeth of the internal gear 266, the number of teeth of the sun gear 278, and the number of teeth of each of the first and second planet gears 318, 322 can be such that they have no common factors other than 1. In the example provided, the number of teeth of the internal gear 266, the number of teeth of the sun gear 278, and the number of teeth of each of the first and second planet gears 318, 322 are different prime numbers. Thus, the second differential 130 can be fully hunting and non-factorizing, while providing asymmetric gearing with more torque directed toward the clutch 134 when the vehicle travels in a straight line and the left and right wheels have full traction.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A disconnecting axle assembly for selectively driving a set of drive wheels of a vehicle, the disconnecting axle assembly comprising:
an input pinion supported for rotation about a first axis;
a first output member supported for rotation about a second axis that is transverse to the first axis and adapted to output torque to a first wheel of the set of drive wheels;
a second output member supported for rotation about the second axis and adapted to output torque to a second wheel of the set of drive wheels;
a differential including a differential input member, a first differential output, a second differential output and a differential gearset, the differential input member being supported for rotation about the second axis and meshingly engaged with the input pinion, the planetary gearset being configured to receive input torque from the differential input member and to output differential torque to the first and second differential outputs, the second differential output being drivingly coupled to the second output member, wherein the differential is configured to output a greater amount of torque to the first differential output than the second differential output when the vehicle is traveling in a straight line; and
a clutch including a plurality of first friction plates, and a plurality of second friction plates, the first friction plates being non-rotatably but axially slidably coupled to the first differential output, the second friction plates being interleaved with the first friction plates and non-rotatably but axially slidably coupled to the first output member.

2. The disconnecting axle assembly of claim 1, wherein the second output member is non-rotatably coupled to the second differential output.

3. The disconnecting axle assembly of claim 1, wherein the differential gearset is a hunting.

4. The disconnecting axle assembly of claim 1, wherein the differential gearset is at least partially non-factorizing.

5. The disconnecting axle assembly of claim 1, wherein the planetary gearset includes an internal gear, a planet carrier, a plurality of planet gears, and a sun gear, wherein the internal gear is non-rotatably coupled to the differential input member, the first differential output is coupled to the planet carrier for common rotation about the second axis and the second differential output is coupled to the sun gear for common rotation about the second axis.

6. The disconnecting axle assembly of claim 5, wherein the internal gear has a total number of teeth and the sun gear has a total number of teeth, wherein the total number of teeth of the internal gear is not a whole number multiple of the total number of teeth of the sun gear.

7. The disconnecting axle assembly of claim 5, wherein the internal gear has a total number of teeth and the sun gear has a total number of teeth, wherein the total number of teeth of the internal gear is greater than twice the total number of teeth of the sun gear.

8. The disconnecting axle assembly of claim 5, wherein the plurality of planet gears includes a set of first planet gears and a set of second planet gears, the first planet gears being meshingly engaged with the sun gear, each of the second planet gears being meshingly engaged with the internal gear and a corresponding one of the first planet gears.

9. The disconnecting assembly of claim 8, wherein a total number of teeth of each first planet gear, a total number of teeth of each second planet gear, a total number of teeth of the internal gear, and a total number of teeth of the sun gear are different prime numbers.

10. The disconnecting axle assembly of claim 1, wherein the planetary gearset includes an internal gear, a planet carrier, a plurality of planet gears, and a sun gear, wherein the internal gear is non-rotatably coupled to the differential input member, the first differential output is coupled to the sun gear for common rotation about the second axis and the second differential output is coupled to the planet carrier for common rotation about the second axis.

11. The disconnecting axle assembly of claim 10, wherein the internal gear has a total number of teeth and the sun gear has a total number of teeth, wherein the total number of teeth of the internal gear is less than twice the total number of teeth of the sun gear.

12. The disconnecting axle assembly of claim 11, wherein the plurality of planet gears includes a set of first planet gears and a set of second planet gears, the first planet gears being meshingly engaged with the sun gear, each of the second planet gears being meshingly engaged with the internal gear and a corresponding one of the first planet gears.

13. The disconnecting axle assembly of claim 12, wherein a total number of teeth of each first planet gear, a total number of teeth of each second planet gear, a total number of teeth of the internal gear, and a total number of teeth of the sun gear are different prime numbers.

14. The disconnecting axle assembly of claim 13, wherein the set of first planet gears consists of 3 of the first planet gears and the set of the second planet gears consists of 3 of the second planet gears.

15. The disconnecting axle assembly of claim 1, further comprising a housing assembly, the housing assembly including a main housing, a first end cap, and a second end cap, the first end cap and a first side of the main housing defining a clutch cavity, the second end cap and a second side of the main housing defining a differential cavity spaced apart from the clutch cavity, the main housing including a central bore disposed about the second axis, the central bore connecting the clutch cavity with the differential cavity, wherein the differential is disposed within the differential cavity and the clutch is disposed within the clutch cavity.

16. The disconnecting axle assembly of claim 1, wherein the input pinion is disposed axially between the clutch and the differential relative to the second axis.

17. A disconnecting axle assembly for selectively driving a set of drive wheels of a vehicle, the disconnecting axle assembly comprising:
a housing assembly;
an input pinion supported for rotation relative to the housing assembly about a first axis;
a first axle half-shaft extending through a first side of the housing assembly and supported for rotation relative to the housing assembly about a second axis that is transverse to the first axis;
a second axle half-shaft extending through a second side of the housing assembly and supported for rotation relative to the housing assembly about the second axis;
a differential disposed within the housing assembly and including a differential input gear, a first differential output, a second differential output, an internal gear, a planet carrier, a plurality of first planet gears, a plurality of second planet gears, and a sun gear, the differential input gear being meshingly engaged with the input pinion, the internal gear being non-rotatably coupled to the differential input gear, the planet carrier supporting the first and second planet gears for rotation relative to the housing assembly about the second axis, the first planet gears being meshingly engaged with the sun gear, each second planet gear being meshingly engaged with the internal gear and a corresponding one of the first planet gears, wherein one of the sun gear or the planet carrier is non-rotatably coupled to the second axle half-shaft; and
a clutch including a plurality of first friction plates and a plurality of second friction plates, the first friction plates being non-rotatably but axially slidably coupled to the other one of the sun gear or the planet carrier, the second friction plates being interleaved with the first friction plates and non-rotatably but axially slidably coupled to the first axle half-shaft;
wherein the differential is configured to output a greater amount of torque to the first friction plates than to the second axle half-shaft when an equal amount of rotational resistance is applied to the first and second axle half-shafts.

18. The disconnecting axle assembly of claim 17, wherein the internal gear, the first planet gears, the second planet gears, and the sun gear form a hunting and non-factorizing gearset.

19. The disconnecting axle assembly of claim 17, wherein a total number of teeth of each first planet gear is equal to a total number of teeth of each second planet gear, and wherein a total number of teeth of the internal gear, a total number of teeth of the sun gear, and the total number of teeth of each of the first and second planet gears have no common factors other than 1.

20. The disconnecting axle assembly of claim 17, wherein a total number of teeth of each first planet gear, a total number of teeth of each second planet gear, a total number of teeth of the internal gear, and a total number of teeth of the sun gear are different prime numbers.
